(19) United States
(12) Patent Application Publication
(10) Pub. No.: US 2012/0234936 A1
(43) Pub. Date: Sep. 20, 2012

(54) FOAM SPRAYING RIG

(76) Inventor: Richard C. Hugg, Westside, IA (US)

(21) Appl. No.: 13/420,237

(22) Filed: Mar. 14, 2012

Related U.S. Application Data
(60) Provisional application No. 61/452,737, filed on Mar. 15, 2011.

(51) Int. Cl. B05B 7/16

(52) U.S. Cl. 239/128

(57) ABSTRACT

A foam spraying rig having an engine, a compressor and a hydraulic system positioned within a compartment. The foam spraying rig has a heat exchanger positioned within the compartment, and a fluid line connected to the engine, compressor and hydraulic system passes through the heat exchanger. A first storage tank containing a first material and a second storage tank containing a second material is positioned within the compartment. The first and second materials are conveyed through the heat exchanger through fluid lines which connect to a proportioner which meters the first and second material at specified proportions. The proportioner is fluidly connected to a dispenser which mixes the first and second material before it is dispensed. This arrangement of components within the compartment and the use of the heat exchanger warms the first and second materials to an operative temperature in a quick, inexpensive, low maintenance and durable manner.

### CROSS REFERENCE TO RELATED APPLICATION

This application claims the benefit of U.S. Provisional Application No. 61/452,737 filed Mar. 15, 2011.

### BACKGROUND OF THE INVENTION

This invention is directed toward a foam spraying rig and more particularly to a foam spraying rig with an improved heating system.

Plural component foams, spray foams and polyurea coatings are used as insulation and as liners for truck bodies and other applications. At least two components are combined and discharged from a spray nozzle at approximately 150° F. under a pressure of approximately 1500 psi or more. The equipment available today for applying the product derives from the commercial factory foam industry such as boat hull fill or factory foamed panels for buildings and cold storage. The equipment is meant to be used in a controlled environment and a relatively unabusive manner. The use of the equipment into the mobile market of home and industrial building insulation has been accomplished by taking the delicate equipment, mating it to a large mobile generator, and placing the equipment in a truck along with barrels of raw material and approximately 300 feet of fragile hose.

The problems associated with current prior art mobile equipment primarily are associated with the heating system. For example, current heating systems require many parts, are expensive to manufacture, and are costly to repair. In addition, current heating systems do not generate enough heat and are inefficient requiring a substantial amount of time and energy to generate an acceptable amount of heat. Therefore, a need exists in the art for a foam spraying rig that addresses these problems.

### SUMMARY OF THE INVENTION

A foam spraying rig having an engine, a compressor and a hydraulic system positioned within a compartment. The foam spraying rig has a heat exchanger positioned within the compartment, and a fluid line connected to each of the engine, compressor and hydraulic system passes through the heat exchanger. At a first storage tank containing a first material and a second storage tank containing a second material is positioned within the compartment. The first material and second material is conveyed through the heat exchanger through fluid lines which connect to a proportioner which meters the first and second material at specified proportions. The proportioner is fluidly connected to a dispenser which mixes the first and second material before it is dispensed. The unique arrangement of these components positioned within the compartment and the use of the heat exchanger warms the first and second materials to an operative temperature in a quick, inexpensive, low maintenance and durable manner.

### BRIEF DESCRIPTION OF THE DRAWINGS

FIG. 1 is a plan view schematic of a foam spraying rig.

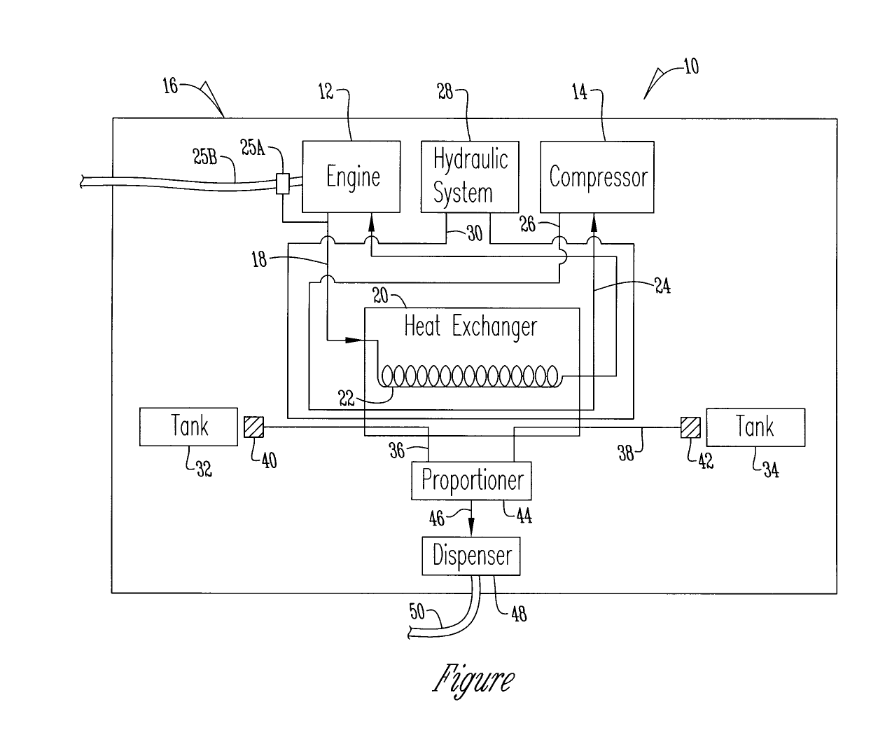

### DETAILED DESCRIPTION FO THE PREFERRED EMBODIMENT

Referring to the Figures, the foam spraying rig 10 has an engine 12 and a compressor 14 enclosed in a compartment 16. The engine 12 has a discharge line or conduit 18 which carries coolant such as glycol to a heat exchanger 20. The discharge line 18 is connected to an exchanger line 22 comprised of a plurality of continuous coils disposed within the heat exchanger 20. The opposite end of exchanger line 22 is connected to an engine input line 24 that is connected to the engine 12 to form a closed loop between the engine 12 and the heat exchanger 20. A water jacket 21 may be placed around the engine's exhaust to further heat the water/coolant pumped through line 18.

The compressor 14 has an oil line 26 that extends from the compressor 14, through the heat exchanger 20 and back to the compressor 14. Oil moves through oil line 26 by compressed air, a fluid pump, or any other motive force.

In one embodiment a hydraulic system 28 is positioned between and connected to the engine 12 and the compressor 14. A hydraulic flow path is provided from the hydraulic system 28, through the heat exchanger 20, and back to the hydraulic system 28.

Within the compartment 16 are at least a pair of storage tanks 32 and 34 respectively. The tanks 32 and 34 contain material that is to be mixed for application. Each tank 32 and 34 has a line 36 and 38 respectively that are connected to and extend through displacement pumps 40 and 42. While described as utilizing a displacement pump 40, 42 compressed air, a fluid pump, or gravity similarly can be used to move the material as is known in the art. From displacement pumps 40 and 42, material lines 36 and 38 extend into and through the heat exchanger 20. From the heat exchanger 20, material lines 36 and 38 are connected to a proportioner 44 where material from lines 36 and 38 are metered at a desired proportion. From the proportioner 44 a proportioner line 46 extends to a dispenser 48 where material is mixed prior to being discharged through a dispenser line 50.

In operation the engine 12 and compressor 14 are started causing water/coolant to flow from the engine 12 through line 18 to the heat exchanger line 22, then to the engine input line 24 and back to the engine 10. In one embodiment the water/coolant is pumped through a water jacket 25A where the water/coolant is heated from the exhaust 25B of the engine 12. Likewise, oil flows from the compressor 14 through line 26 to the heat exchanger 20 and back to the compressor 14. In another embodiment, hydraulic fluid flows from the hydraulic system 28 through line 30 to the heat exchanger 20 and back to the hydraulic system 28.

Foam material is then pumped from tanks 32 and 34 to proportioner 44 through lines 36 and 38. As material passes through the heat exchanger 20 within lines 36 and 38 the material is heated by the coolant in exchanger line 22, the oil in oil line 26, the hydraulic fluid in line 30 or any combination of the three. To improve heating, an external, or additional heater is added to the compartment 16 and/or the heat exchanger 20.

From the above discussion, it will be appreciated that a foam spraying rig is presented which offers many advantages over the prior art. Namely, the foam spraying rig offers an inexpensive and durable heating system that is less complicated and has less parts, and requires less maintenance and cost to maintain. In addition, the foam spraying rig generates the requisite amount of heat in an a fast and efficient manner.

It will be appreciated by those skilled in the art that other various modifications could be made to the device without parting from the spirit and scope of this invention. All such modifications and changes fall within the scope of the claims and are intended to be covered thereby.

What is claimed:

1. A foam spraying rig, comprising:
an engine and a compressor positioned within a compartment;
a heat exchanger positioned within the compartment;
a discharge line connected to the engine and passing through the heat exchanger;
an oil line connected to the compressor and passing through the heat exchanger;
at least one storage tank containing material positioned within the compartment;
a fluid line connected to the storage tank and passing through the heat exchanger;
wherein when the material passes through heat exchanger it is warmed.

2. The foam spraying rig of claim 1, wherein the discharge is connected to an exchanger line 22 comprised of a plurality of continuous coils disposed within the heat exchanger.

3. The foam spraying rig of claim 1 further comprising a hydraulic system positioned within the compartment.

4. The foam spraying rig of claim 3 further comprising a hydraulic fluid line connected to the hydraulic system passing through the heat exchanger.

5. The foam spraying rig of claim 1 wherein the engine has an exhaust and the discharge line connects to a water jacket positioned around the exhaust.

6. The foam spraying rig of claim 1 further comprising a proportioner positioned within the compartment and fluidly connected to the fluid line.

7. The foam spraying rig of claim 1 further comprising a dispenser positioned within the compartment and fluidly connected to the fluid line.

8. A foam spraying rig, comprising:
an engine positioned within a compartment;
a heat exchanger positioned within the compartment;
a discharge line connected to the engine and passing through the heat exchanger;
a first storage tank containing a first material positioned within the compartment;
a first fluid line connected to the first storage tank and passing through the heat exchanger;
wherein when the first material passes through heat exchanger it is warmed;
a proportioner positioned within the compartment and fluidly connected to the first fluid line;
wherein the proportioner meters the first material at a desired proportion.

9. The foam spraying rig of claim 8 further comprising a compressor positioned within the compartment and an oil line connected to the compressor which passes through the heat exchanger.

10. The foam spraying rig of claim 8 further comprising a hydraulic system positioned within the compartment and a hydraulic fluid line connected to the hydraulic system which passes through the heat exchanger.

11. The foam spraying rig of claim 8 further comprising a second storage tank containing a second material positioned within the compartment and a second fluid line connected to the second storage tank and the proportioner.

12. A foam spraying rig, comprising:
an engine positioned within a compartment;
a heat exchanger positioned within the compartment;
a discharge line connected to the engine and passing through the heat exchanger;
a first storage tank containing a first material positioned within the compartment;
a first fluid line connected to the first storage tank and passing through the heat exchanger;
wherein when the first material passes through heat exchanger it is warmed;
a dispenser positioned within the compartment and fluidly connected to the first fluid line;
wherein the dispenser mixes the first material prior to dispensing.

13. The foam spraying rig of claim 12 further comprising a compressor positioned within the compartment and an oil line connected to the compressor which passes through the heat exchanger.

14. The foam spraying rig of claim 12 further comprising a hydraulic system positioned within the compartment and a hydraulic fluid line connected to the hydraulic system which passes through the heat exchanger.

15. The foam spraying rig of claim 12 further comprising a second storage tank containing a second material positioned within the compartment and a second fluid line connected to a second storage tank and the proportioner.

16. The foam spraying rig of claim 12 further comprising a proportioner positioned within the compartment and fluidly connected to the first fluid line wherein the proportioner meters the first material at a desired proportion.
